(19) United States
(12) Patent Application Publication
(10) Pub. No.: US 2011/0043707 A1
(43) Pub. Date: Feb. 24, 2011

(54) CONTENT TRANSMITTING DEVICE

(75) Inventor: Takamasa Umezu, Yokohama-shi (JP)

Correspondence Address: NIXON & VANDERHYE, PC, 901 NORTH GLEBE ROAD, 11TH FLOOR, ARLINGTON, VA, 22203, US

(73) Assignee: PIONEER CORPORATION, Kawasaki-shi, Kanagawa (JP)

(21) Appl. No.: 12/934,933

(22) PCT Filed: Mar. 27, 2008
(86) PCT No.: PCT/JP2008/055820

§ 371 Date: Nov. 2, 2010

(51) Int. Cl. H04N 5/38

(52) U.S. Cl. 348/723; 348/E05.093

(57) ABSTRACT

A content transmitting device 10 is connected with a content receiving device 40 via any one of a category 1 HDMI cable 30 and a category 2 HDMI cable 30 and is provided with a content transmitting means. The content transmitting means performs: a process to determine a clock frequency of a signal to be outputted such that the clock frequency is equal to or less than a band frequency of the category 1 HDMI cable 30; a process to output, at the clock frequency determined by the first clock frequency determining process, a selection screen for selecting whether to set a transmitting mode corresponding to the category 2 HDMI cable 30; a process to redetermine the clock frequency of a signal to be outputted when receiving information representing that the transmitting mode corresponding to the category 2 HDMI cable 30 is set; and a process to output, at the redetermined clock frequency, a content to the content receiving device.

### TECHNICAL FIELD OF THE INVENTION

The present invention relates to content transmitting devices, and is preferably applicable to content transmitting devices equipped with an interface, such as an HDMI (High-Definition Multimedia Interface).

### BACKGROUND ART

HDMI (High-Definition Multimedia Interface) is popular as an interface for AV (Audio-Visual) devices. A plurality of cables for each of video, audio, and control signals were conventionally used for connection among devices, but HDMI can simply connect devices with each other and control a plurality of AV devices by a single remote controller because they require one cable, and their control signals allow bidirectional transmission. Because AV systems equipped with HDMI transmit video and audio among devices by digital signals, they allow contents to be viewed without their high-quality images and sounds being deteriorated.

Technologies using such an HDMI include a technology disclosed in, for example, a first patent document described later. In the first patent document, a content transmitting device (Source) equipped with an HDMI output terminal for DVD (Digital Versatile Disc) players acquires information (EDID: Extended Display Identification Data), such as video specification and audio-output specification of devices from a content receiving device (Sink) equipped with an HDMI input terminal for monitors and televisions (TV), and transmits video and audio signals that meet the specifications of a device.

First patent document: Japanese Patent Laid-Open No. 2005-109703

### DISCLOSURE OF THE INVENTION

### Problems to be Solved by the Invention

As HDMI cables to be used to connect between the content transmitting device and the content receiving device, there are two categories of cables: category 1 (standard) cables and category 2 (high-speed) cables. The two categories of HDMI cables are different in guaranteed transmission bandwidth from each other. Specifically, the category 1 cables have a guaranteed transmission bandwidth of 74.25 MHz, and the category 2 cables have a guaranteed transmission bandwidth of 340 MHz.

As described above, in AV systems connected by HDMI, contents of high-quality images and sounds can be enjoyed without their signals being deteriorated. In addition, contents can be displayed in optimal conditions that meet the specifications of a monitor or a television.

However, some images may not be displayed or some sounds may not be outputted due to an HDMI cable connecting both devices because of the difference between their transmission bandwidths of the HDMI cables. For example, connection of a content transmitting device and a content receiving device with a category 1 HDMI cable may cause some images not to be displayed or some sounds not to be outputted when a clock frequency (TMDS clock frequency) for transmission of contents is higher than 74.25 MHz.

As described above, even if a content transmitting device or a content receiving device is capable of playing back sufficiently high image quality and high sound quality contents and displaying them, these AV systems connected by HDMI may not display some images or not output some sounds due to the category of an HDMI cable that connects the devices.

In this case, because users often don't recognize the category of an HDMI cable to be used, they cannot understand what causes some images not to be displayed. This may result in the occurrence of complaints against both of the devices.

The present invention has been made in view of the aforementioned circumstances, and has an example of a purpose of providing content transmitting devices; these devices are capable of:

reducing malfunctions due to cables, which include a malfunction of some images being not displayed and/or a malfunction of some sounds being not outputted; and

enabling users to recognize, even if such a malfunction occurs, that the malfunction results from a corresponding cable.

### Means for Solving the Problems

In order to achieve such a purpose provided above, a content transmitting device according to an invention recited in claim 1 is connected with a content receiving device via any one of two types of first and second cables and adapted to transmit a content to the content receiving device. The first cable has a guaranteed transmission bandwidth with a first frequency, and the second cable has a guaranteed transmission bandwidth higher than the first frequency. The content transmitting device includes a content transmitting means. The content transmitting means performs a device-information acquiring process to acquire, from the content receiving device, information associated with a specification of the content receiving device, a first clock frequency determining process to determine an output format and a clock frequency on ground that the acquired information associated with the specification of the content receiving device such that the clock frequency of a signal to be outputted is equal to or less than the first frequency, a first output control process to output, at the clock frequency determined by the first clock frequency determining process, a selection screen for selecting whether to set a transmitting mode corresponding to the second cable, and a second clock frequency determining process to determine an output format and a clock frequency of a signal to be outputted on ground that the acquired information associated with the specification of the content receiving device when receiving information representing that the transmitting mode corresponding to the second cable is set, and determine holding of the output format and the clock frequency determined by the first clock frequency determining process when receiving information representing that the transmitting mode corresponding to the second cable is unset. The content transmitting means performs a second output control process to output, at the clock frequency determined by the second clock frequency determining process, a content to the content receiving device.

### BRIEF DESCRIPTION OF THE DRAWINGS

FIG. 1 is a schematic structural view of a content transmitting/receiving system according to an embodiment of the present invention;

FIG. 2 is a view specifically illustrating an output-format determining method in a content transmitting device according to the embodiment of the present invention;

FIG. 3 is an example of a data structure of EDID information stored in a content receiving device according to the embodiment of the present invention;

FIG. 4 is a flowchart illustrating an output-format determining task by the content transmitting device according to the embodiment of the present invention;

FIG. 5 is a flowchart illustrating a first modification of the output-format determining task by the content transmitting device according to the embodiment of the present invention;

FIG. 6 is a flowchart illustrating a second modification of the output-format determining task by the content transmitting device according to the embodiment of the present invention;

FIG. 7 is a flowchart illustrating a third modification of the output-format determining task by the content transmitting device according to the embodiment of the present invention;

FIG. 8 is a flowchart illustrating a fourth modification of the output-format determining task by the content transmitting device according to the embodiment of the present invention; and

FIG. 9 is a flowchart illustrating a fifth modification of the output-format determining task by the content transmitting device according to the embodiment of the present invention.

### DESCRIPTION OF CHARACTERS

1 Optical disk

10 Content transmitting device

11 Signal reader

12 Signal processor

13 Video demodulator

14 Video converter

15 Audio demodulator

16 Audio converter

17 HDMI transmitter

18 GUI generator

19 Operating unit

20 CPU

21 Storage unit

30 HDMI cable

31 TMDS link

32 DDC line

33 HPD line

40 Content receiving device

41 HDMI receiver

42 EDID ROM

100 Content transmitting/receiving system

141 Resolution converter

142 Bit-number converter

143 Pixel-repetition converter

d10 EDID information

### BEST MODE FOR CARRYING OUT THE INVENTION

Embodiments of the present invention will be described hereinafter with reference to the drawings.

<Structure>

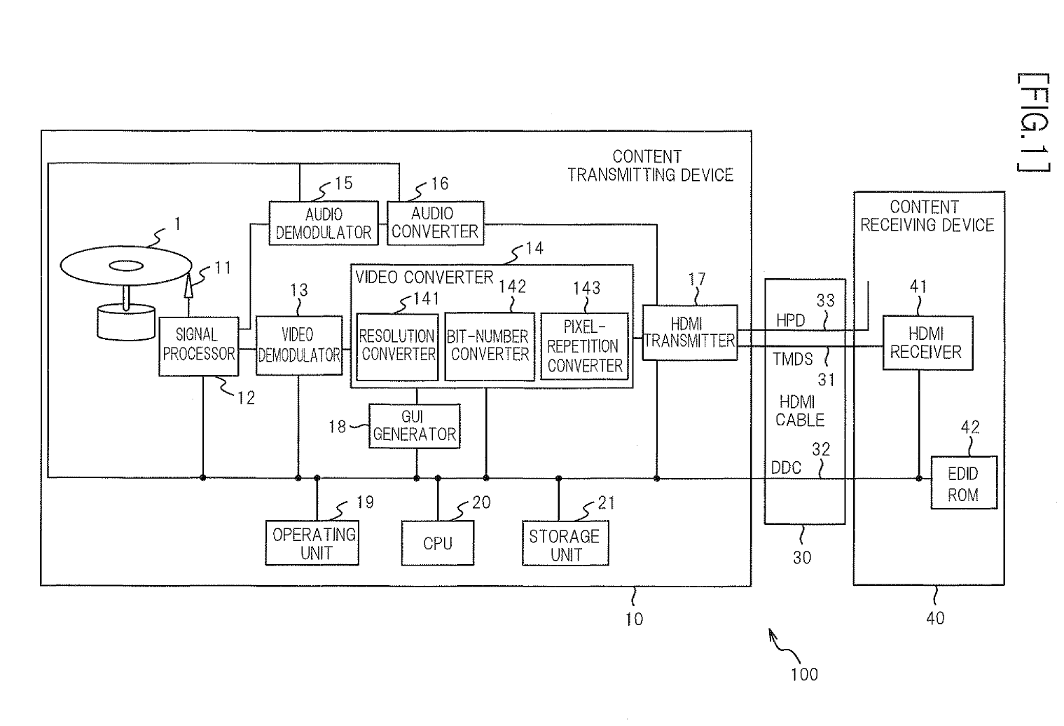

FIG. 1 illustrates the schematic structure of a content transmitting/receiving system 100 according to an embodiment of the present invention. The content transmitting/receiving system 100 is an AV system capable of transmitting and receiving digital signals and control signals that conform to HDMI (High-Definition Multimedia Interface) specifications. In the content transmitting/receiving system 100, a content transmitting device (Source) 10 and a content receiving device (Sink) 40 are connected with each other via an HDMI cable 30.

The content transmitting device 10 is a content player with HDMI output terminals, such as a BD (Blu-ray Disc) player, a BD recorder, a DVD (Digital Versatile Disc) player, a DVD recorder, a HDD (Hard Disk Drive) recorder, and a digital camera. Functions of the content transmitting device 10 for playing back an optical disc, such as BD, will be described hereinafter.

The content receiving device 40 is a content display with HDMI input terminals, such as a TV (Television) equipped with a display, such as an LCD (Liquid Crystal Display) and a PDP (Plasma Display Panel). Functions of the content receiving device 40 equipped with a display and a speaker will be described hereinafter.

The HDMI cable 30 is comprised of a TMDS (Transition Minimized Differential Signaling) link 31, a DDC (Display Data Channel) line 32, and a CEC (Consumer Electronics Control) line (not shown). The TMDS link 31 is to transmit video and audio signals as digital signals in a differential signaling system. The DDC line 32 is used for transmission of EDID (Extended Display Identification Data) and for HDCP (High-bandwidth Digital Content Protection) authentication. The CEC line is a bidirectional bus line that transmits common control signals (CEC commands) among devices. In the HDMI cable 30, an HPD (Hot Plug Detect) line 33 for notifying of the connection status of connected devices is present.

Specifically, the content transmitting device 10 includes a signal reader 11, a signal processor 12, a video demodulator 13, a video converter 14, an audio demodulator 15, an audio converter 16, an HDMI transmitter 17, a GUI generator 18, an operating unit 19, a CPU 20, and a storage unit 21.

The signal reader 11 is disposed at a position where it can read records on the optical disc 1 as a storage medium, and adapted to read data, such as marks and spaces recorded on the optical disc 1, and to convert it into electric signals.

The signal processor 12 is adapted to convert the signals read by the signal reader 11 into digital signals, and separate the converted digital signals into digital signals of video components and digital signals of audio components.

The video demodulator 13 is adapted to receive the separated digital video signals and to decode them into video signals with a predetermined format.

The video converter 14 is adapted to carry out, under control of the CPU 20, the conversion of an inputted digital video signal in resolution, the number of bits, and pixel-repetition. Although the detailed descriptions will be later, because the CPU 20 determines an output format, specifically including the resolution, the number of bits, and the number of pixel repetitions, on ground that EDID information received from the content receiving device 40 and default setting or user setting in the content transmitting device 10, the video converter 14 is adapted to carry out the conversion of an inputted digital video signal in accordance with the determined output format.

More specifically, the video converter 14 is comprised of a resolution converter 141, a bit-number converter 142, and a pixel-repetition converter 143.

The resolution converter 141 converts the resolution of an inputted digital video signal in accordance with a determined resolution. Specifically, because the number of pixels, the scanning mode (interlace mode or progressive mode), and the frame rate (60 Hz or 50 Hz) have been determined as the resolution (for example, 480i/60 Hz, 480p/60 Hz, 720p/60 Hz, 1080i/60 Hz, 1080p/60 Hz, and so on), the resolution converter 141 converts an inputted digital video signal in accordance with the determined resolution.

The bit-number converter 142 converts the number of bits of an inputted digital video signal in accordance with the determined number of bits. Specifically, as the number of bits, any one of: 24 bits (8 bits per color of RGB or YCbCr, or 12 bits per color of YCb/Cr), 30 bits (10 bits per color of RGB or YCbCr), and 48 bits (16 bits per color of RGB or YCbCr) is set. For this reason, the inputted digital video signal is converted in accordance with the determined number of bits.

The pixel-repetition converter 143 converts the number of pixel-repetitions of an inputted digital video signal in accordance with the determined number of pixel-repetitions. Specifically, because as the number of pixel repetitions, any one of zero, two times, four times, or the like is determined, the pixel-repetition converter 143 converts the inputted digital video signal in accordance with the determined number of pixel-repetitions.

The audio demodulator 15 is adapted to receive the separated digital audio signals and to decode them into audio signals with a predetermined format.

The audio converter 16 is adapted to carry out, under control of the CPU 20, the conversion of an inputted digital audio signal.

The HDMI transmitter 17 is adapted to temporally multiplex a digital video signal and a digital audio signal generated by the video converter 14 and the audio converter 16 to thereby convert them into digital data that conforms to the HDMI specifications. The HDMI transmitter 17 is adapted to transmit the converted digital data to the content receiving device 40 via the HDMI cable 30. Specifically, content data consisting of a digital video signal and a digital audio signal is transmitted to the content receiving device 40 via the TMDS link 31 of the HDMI cable 30.

The HDMI transmitter 17 is also adapted to detect the presence or absence of a connection between the content transmitting device 10 and the content receiving device 40. Specifically, the HDMI transmitter 17 is adapted to receive, from the HPD line 33 of the HDMI cable 30, information associated with the presence or absence of a connection.

The GUI generator 18 is adapted to generate a selection screen for determining whether or not to set the output format to a transmission mode corresponding to the category 2 (high speed) of the HDMI cable 30; this selection screen will be referred to as a “transmitting-mode selection screen” hereinafter. The transmitting-mode selection screen is transmitted to the content receiving device 40 via the HDMI transmitter 17 and the HDMI cable 30. Then, the transmitting-mode selection screen is displayed on the content receiving device 40.

The operating unit 19 is adapted to receive operating information indicative of operating instructions for the content transmitting device 10 from a user, and output the operating information to the CPU 20. In this embodiment, after the display of the transmitting-mode selection screen, the operating information indicative of whether to set the output format to the transmission mode corresponding to the category 2 (high speed) is designed to be received.

The CPU 20 is adapted to control overall operations of the content transmitting device 10 including content playback operations and content transmitting operations. For example, the CPU 20 is adapted to control each section of the content transmitting device 10 according to operating information so as to reflect the operating information. In addition, the output format is determined based on the EDID information acquired from the content receiving device 40 and information set by the content transmitting device 10, and a played-back content is controlled to be transmitted by the determined output format to the content receiving device 40. At that time, in this embodiment, the selection screen to determine whether or not to set the output format to the transmission mode corresponding to the category 2 (high speed) of the HDMI cable 30 is displayed on the content receiving device 40, and the transmitting mode (output format) is determined according to user's selection.

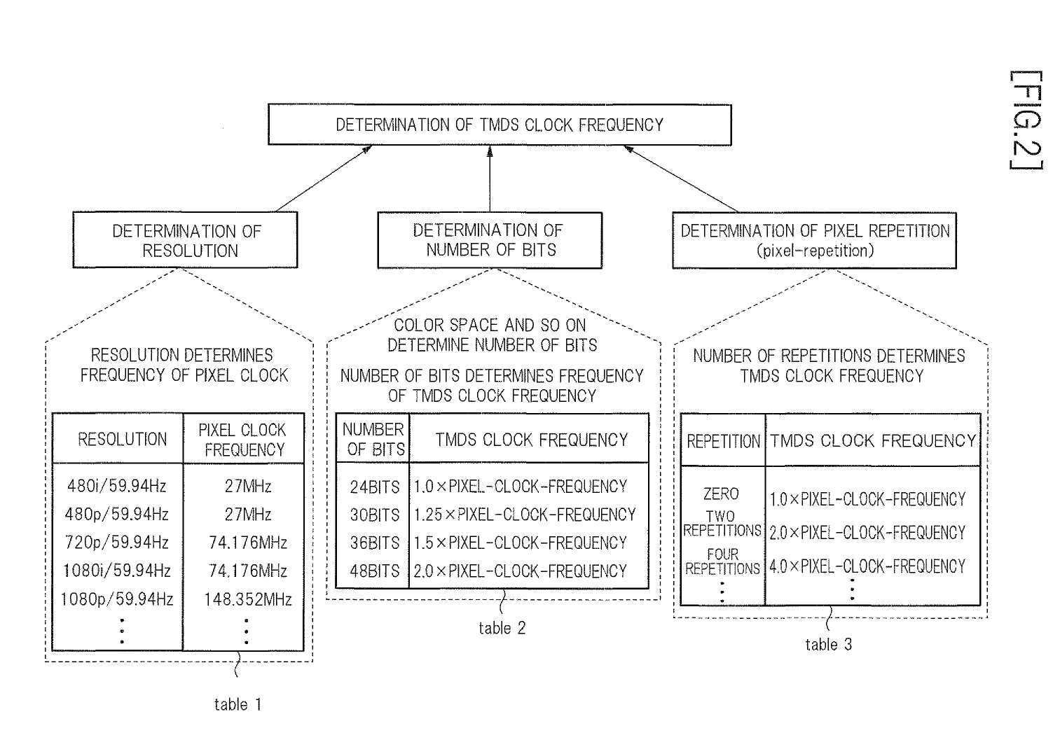

Let us describe determination of the output format by the content transmitting device 10 according to this embodiment with reference to FIG. 2.

As described above, determination of the resolution, the number of bits, and the pixel-repetition determines the output format. This results in determination of the TMDS clock frequency for transmitting content data.

For example, referring to FIG. 2, when the resolution, the number of bits, and the pixel-repetition are set to 480p/59.94 MHz, 24 bits, and zero, respectively, a pixel clock frequency is determined to 27 MHz from table 1, the TMDS clock frequency is determined to be 1.0 times the determined pixel clock frequency from table 2, and the TMDS clock frequency is determined to be 1.0 times the determined pixel clock frequency from table 3. That is, the TMDS clock frequency is set to be 27 MHz (=27×1.0×1.0).

Thus, in this case, because the TMDS clock frequency is equal to or less than 74.25 MHz, the content receiving device 40 can reliably output images and sounds irrespective of using any one of the category 1 (standard) HDMI cable 30 and the category 2 (high-speed) HDMI cable 30.

In addition, when the resolution, the number of bits, and the pixel-repetition are set to 1080p/59.94 MHz, 36 bits, and zero, respectively, a pixel clock frequency is determined to 148.352 MHz from table 1, the TMDS clock frequency is determined to be 1.5 times the determined pixel clock frequency from table 2, and the TMDS clock frequency is determined to be 1.0 times the determined pixel clock frequency from table 3. That is, the TMDS clock frequency is set to be 222.528 MHz (=148.352×1.5×1.0).

Thus, in this case, because the TMDS clock frequency exceeds 74.25 MHz, if the category 1 (standard) HDMI cable 1 were used, the possibility that the content receiving device 40 could not output images and sounds would be high.

The storage unit 21 is made up of a ROM storing therein control programs to be executed by the CPU 20, a RAM for storing therein temporal data during the CPU 20 operating, a nonvolatile memory for storing therein various set information and control information, and an auxiliary memory, such as a hard disk, for storing various data. Note that the control programs can be stored in a storage medium, such as a carriable flash memory, CD-ROM, MO, and DVD-ROM, readable by an AV device or a computer, and can be delivered through a communication network.

In this embodiment, default setting information to which the CPU 20 refers for determining the output format, such as factory default information that has been already set at the factory, user setting information, such as information that has been set by users for the output format, and other information are stored in the storage unit 21.

On the other hand, the content receiving device 40 includes an HDMI receiver 41. The HDMI receiver 41 is adapted to receive, through the TMDS link 31, digital data that conforms to the HDMI specifications, and recover digital video and audio signals from the received digital data. Note that the recovered digital data is subjected to video processing and audio processing by predetermined structural members not shown. This results in that images are displayed on the display and sounds are outputted from the speaker.

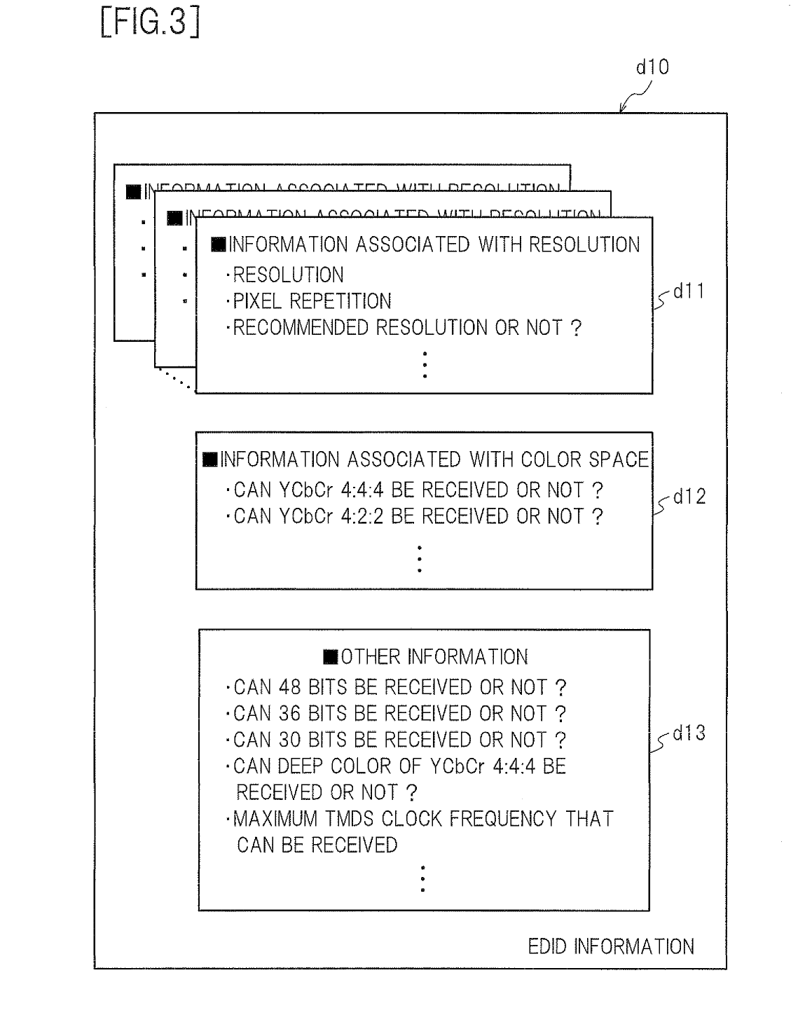

The HDMI receiver 41 is also adapted to transmit the EDID information stored in an EDID ROM 42 to the content transmitting device 10 via the DDC line 32 of the HDMI cable 30. The EDID information includes device-specific information for specifying the content receiving device 40 and information associated with video specifications and audio-output specifications of the content receiving device 40. The content transmitting device 10 is adapted to determine, based on the EDID information d10 received thereby, the output format best suited for the specifications of the content receiving device 40. FIG. 3 illustrates an example of the data structure of the EDID information d10.

Referring to FIG. 3, the EDID information d10 includes:

information d11 associated with one or more resolutions, such as information including a resolution, a pixel repetition, and information indicative of whether the resolution is a recommended resolution;

information d12 associated with a color space, such as information including: information indicative of whether YCbCr 4:4:4 can be received, and information indicative of whether YCbCr 4:2:2 can be received; and

other information d13 including: information indicative of whether 48 bits can be received, information indicative of whether 36 bits can be received, information indicative of whether 30 bits can be received, information indicative of whether a deep color of YCbCr 4:4:4 can be received, and the maximum TMDS clock frequency that can be received.

<Operations>

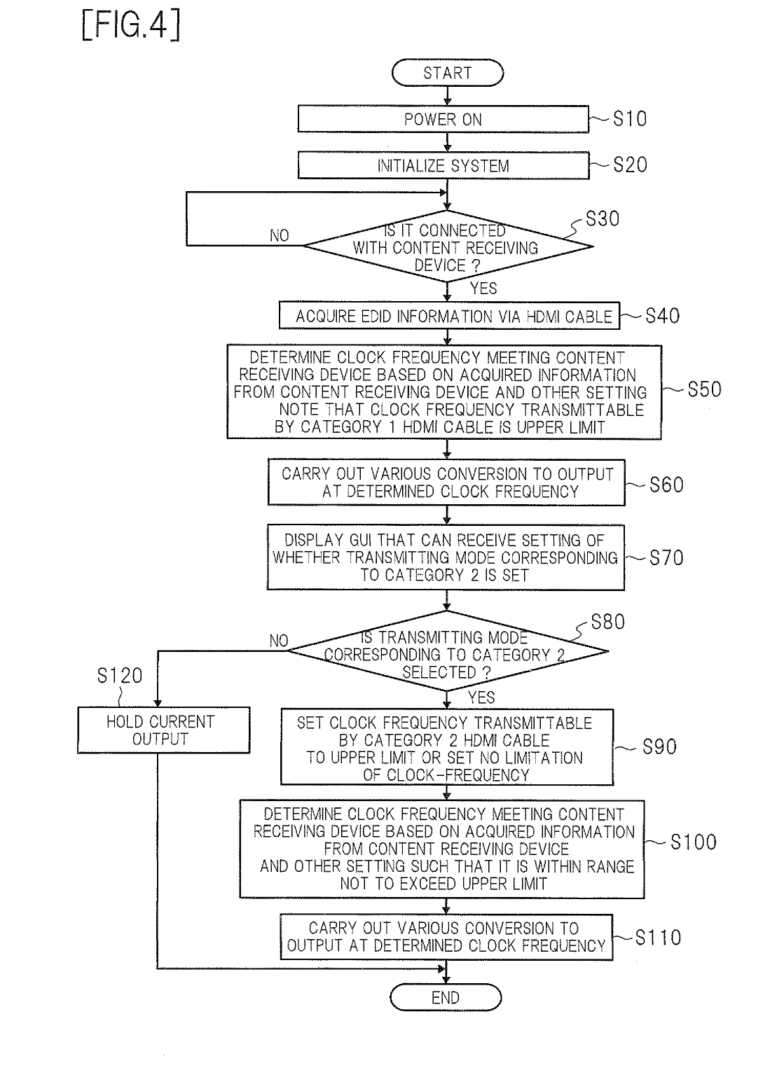

Next, operations of the content transmitting device 10 of the content transmitting/receiving system 100 according to this embodiment will be described with reference to FIG. 4. FIG. 4 is a flowchart illustrating an output-format determining task by the content transmitting device 10.

When the content transmitting device 10 is powered up by a power switch (not shown), the content transmitting device 10 carries out system initialization in step S20.

Next, the content transmitting device 10 determines whether it is connected with the content receiving device 40 in step S30. Specifically, the content transmitting device 10 determines whether it is connected with the content receiving device 40 using the HPD, and determines whether authentication is successful using the HDCP.

Upon determining that the content transmitting device 10 is connected with the content receiving device 40, and the authentication is successful (YES in step S30), the content transmitting device 10 acquires, via the DDC line 32 of the HDMI cable 30, the EDID information d10 from the content receiving device 40 in step S40.

Next, the content transmitting device 40 determines the output format (TMDS clock frequency) based on the default setting information and user setting information stored in the storage unit 21 and on the EDID information acquired from the content receiving device 40 in step S50. Specifically, the output format is determined such that an upper limit of the TMDS clock frequency is within a range transmittable by the category 1 HDMI cable 30, that is, the TMDS clock frequency is equal to or less than 74.25 MHz.

Next, the content transmitting device 10 carries out video-conversion and audio-conversion based on the determined output format, and starts outputs at the determined TMDS clock frequency in step S60.

Next, the content transmitting device 10 generates the selection screen for determining whether or not to set the output format to the transmission mode corresponding to the category 2 HDMI cable 30, and transmits it to the content receiving device 40 in step S70; this selection screen will be referred to as a “transmitting-mode selection screen” hereinafter. Note that, because of the TMDS clock frequency determined in step S50, that is, the transmission mode corresponding to the category 1 HDMI cable 30, such as the output format with the TMDS clock frequency equal to or less than 74.25 MHz, the content receiving device 40 can reliably display the transmitting-mode selection screen.

Next, the content transmitting device 10 receives the operating information from the user to thereby determine whether the transmitting mode corresponding to the category 2 HDMI cable 30 is selected in step S80.

Upon determining that the transmitting mode corresponding to the category 2 HDMI cable 30 is selected (YES in step S80), the content transmitting device 10 sets the upper limit of the TMDS clock frequency to be within a range transmittable by the category 2 HDMI cable 30, that is, sets the TMDS clock frequency to be equal to or less than 340 MHz in step S90. Note that, in this embodiment, the upper limit of the TMDS clock frequency is set to be within the range transmittable by the category 2 HDMI cable 30, but no upper limit of the TMDS clock frequency can be set.

Next, the content transmitting device 10 determines the output format (TMDS clock frequency) based on the default setting information and user setting information stored in the storage unit 21 and on the EDID information acquired from the content receiving device 40 such that the TMDS clock frequency does not exceed the range determined in step S90, in other words, such that the TMDS clock frequency is equal to or less than 340 MHz in step S100.

Next, the content transmitting device 10 carries out video-conversion and audio-conversion based on the determined output format, and starts outputs at the determined TMDS clock frequency in step S110.

This results in that contents played back by the content transmitting device 10 are outputted at the TMDS clock frequency determined in step S100, that is, in the transmitting mode corresponding to the category 2 HDMI cable 30.

Otherwise, upon determining that the transmitting mode corresponding to the category 2 HDMI cable 30 is not selected (NO in step S80), the content transmitting device 10 carries out outputs by the current output format in step S120. This results in that contents played back by the content transmitting device 10 are outputted at the TMDS clock frequency determined in step S50, that is, in the transmitting mode corresponding to the category 1 HDMI cable 30.

As described above, when determining the output format based on the acquired EDID information and so on, the content transmitting device 10 according to this embodiment determines the output format as the transmitting mode corresponding to the category 1 HDMI cable 30, and outputs the transmitting mode selection screen in the determined output format. When receiving information indicative of selection of the transmitting mode corresponding to the category 2 HDMI cable 30 from a user, the content transmitting device 10 changes the output format to the transmitting mode corresponding to the category 2 HDMI cable 30. Thus, it is possible to eliminate a trouble of, due to the HDMI cable 30, the disappearance of images to be displayed and the loss of sounds to be outputted. This is because the user's selection of the transmitting mode allows the output format to be changed to the transmitting mode corresponding to the category 2 HDMI cable 30.

If there were a trouble of, due to the HDMI cable 30, no images being displayed or no sounds being outputted, a user could recognize that the cause for the trouble is the HDMI cable 30 because the user has selected the transmitting mode.

Note that various modifications can be applied to the output-format determining task to be executed by the content transmitting device 10. Each of the modifications will be described hereinafter. Note that steps in the following modifications, which are different from corresponding steps in the above embodiment, will be only described, and therefore, steps in the following modifications, which are the same as corresponding steps in the above embodiment, will be eliminated in description because like reference characters are assigned thereto.

(First Modification)

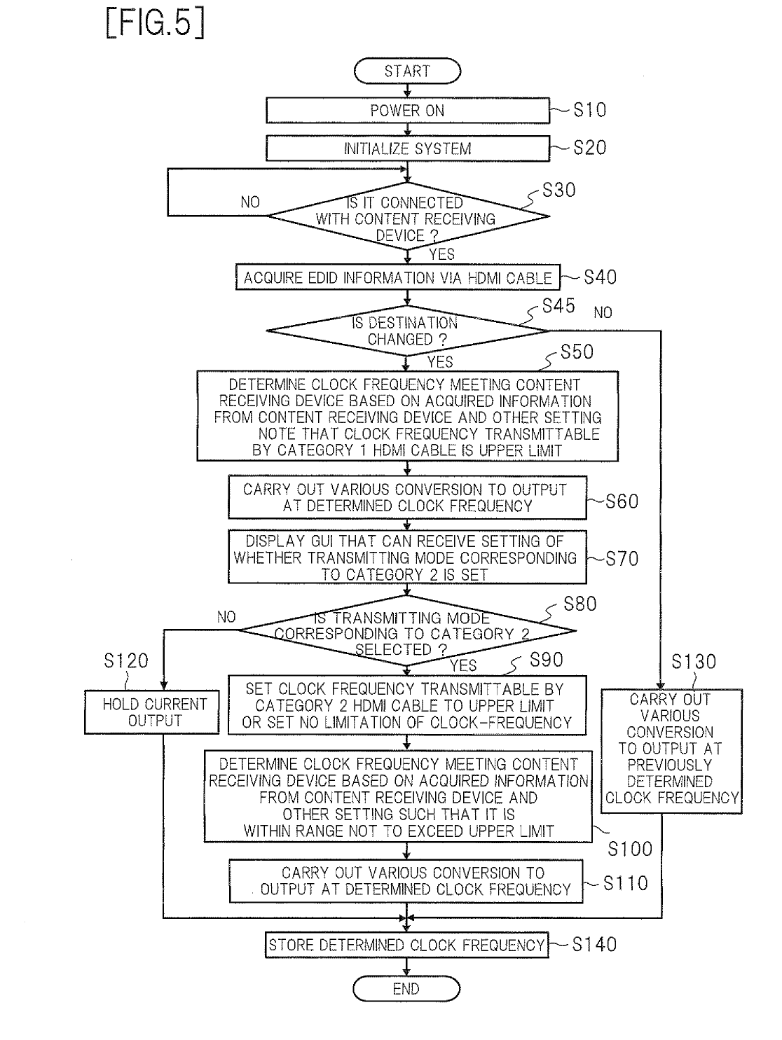

FIG. 5 is a flowchart illustrating a first modification of the output-format determining task to be executed by the content transmitting device 10.

In this modification, the information to be used for determining the output format, such as the EDID information d10, the default setting information, the user setting information, and so on, and the information associated with the determined output format, such as the resolution, the number of bits, the pixel repetition, the TMDS clock frequency, and so on are stored in the storage unit 21. During the content receiving device 40 as the destination being kept unchanged, outputs are carried out in accordance with the output format stored in the storage unit 21 without the process for determining the output-format determination being carried out, and when the content receiving device 40 as the destination is changed, the output format is determined.

Specifically, this modification simplifies the output-format determining task such that determination of the output format is not carried out each time of power up, but is carried out only when the content receiving device 40 is changed. The reason why the output format is reset when the content receiving device 40 is changed is, even if the HDMI cable 30 is not changed, to address a trouble of the disappearance of a displayed image or the loss of an outputted sound.

Because operations in steps S10 to S40 of FIG. 5 are the same as those in the embodiment, they are omitted in description, and therefore descriptions are started from step S45.

The content transmitting device 10 determines, based on the acquired EDID information d10, whether or not the content receiving device 40 as the destination has been changed in step S45. Because the EDID information d10 includes the device-specific information that specifies the content receiving device 40, comparison between the device-specific information of the EDID information d10 stored in the storage unit 21 and that of the acquired EDID information d10 allows determination of whether or not the content receiving device 40 has been changed.

Upon determining that the content receiving device 40 as the destination has been changed (YES in step S45), the content transmitting device 10 determines the output format that meets a new content receiving device 40. Specifically, the content transmitting device 10 carries out the operations in steps S50 to S120 described in the embodiment to determine the output format (TMDS clock frequency), thus outputting played-back contents in the determined output format.

Otherwise, upon determining that the content receiving device 40 as the destination has not been changed (NO in step S45), the content transmitting device 10 refers to the storage unit 21 to retrieve the information associated with the previously determined output format, carries out video-conversion and sound-conversion based on the retrieved output format, and starts outputs at the retrieved TMDS clock frequency in step S130.

Accordingly, this modification eliminates the need to determine the output format each time of power up, and carries out determination of the output format only when the content receiving device 40 is changed, thus reducing the frequency of execution of the process for determining the output format.

In addition, even if the content receiving device 40 has been changed, because the output format is changed to the transmitting mode corresponding to the category 2 HDMI cable 30 in response to the user's selection of the transmission mode, it is possible to reduce a failure of, due to the HDMI cable 30, the disappearance of images to be displayed and the loss of sounds to be outputted.

(Second Modification)

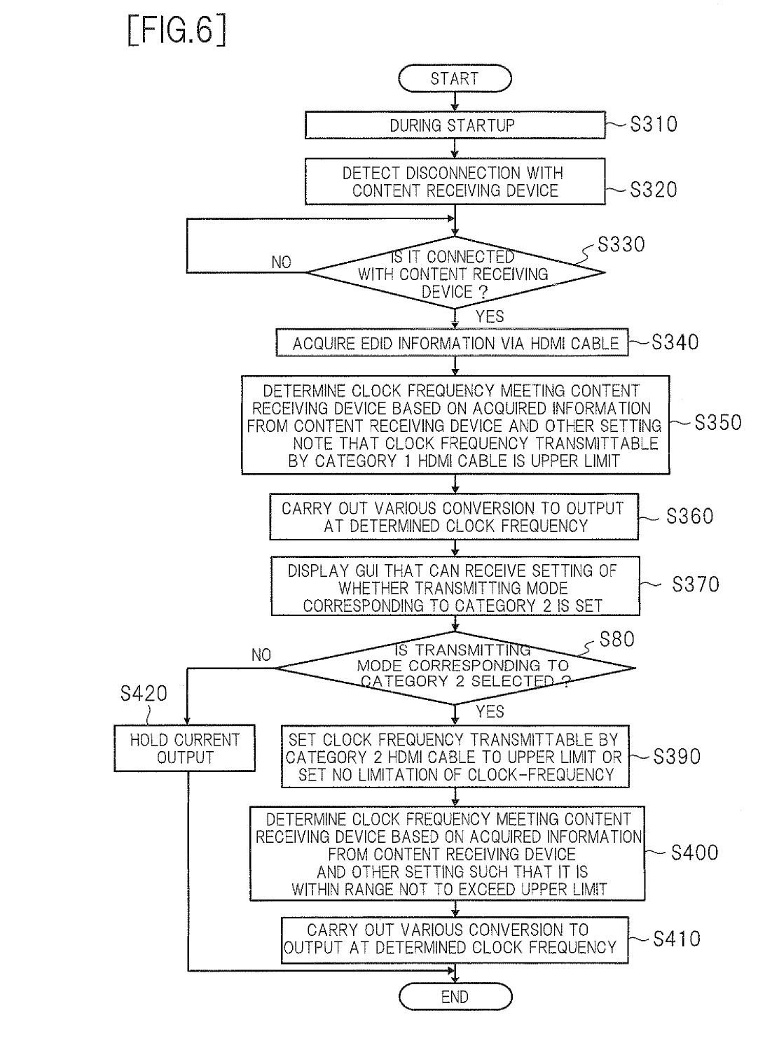

FIG. 6 is a flowchart illustrating a second modification of the output-format determining task to be executed by the content transmitting device 10.

This modification shows an output-format determining task after determination of the output format at power up in accordance with the output-format determining task of the embodiment; this output-format determining task of this modification is carried out when, after detection of disconnection with the content receiving device 40 as the destination, reconnection with the content receiving device 40 is detected.

Specifically, this modification is designed to set the output format at reconnection with the content receiving device 40 after disconnection with the content receiving device 40. When there is disconnection with the content receiving device 40, the HDMI cable 30 may be changed. When the HDMI cable 30 is changed, there may be a trouble of the disappearance of a displayed image and the loss of an outputted sound. This design of this modification addresses such a trouble.

During startup (step S310), when determining that disconnection with the content receiving device 40 in step S320, the content transmitting device 10 determines whether it is reconnected with the content receiving device 40 in step S330. Note that the disconnection between the content transmitting device 10 and the content receiving device 40 is determined using the HPD and HDCP. In addition, the reconnection between the content transmitting device 10 and the content receiving device 40 is determined using the HPD and HDCP.

When reconnected with the content receiving device 40 (YES in step S330), the content transmitting device 10 determines the output format that meets the reconnected content receiving device 40, that is, carries out operations in steps S340 to S420 that are the same as the operations in steps S40 to S120 to determine the output format (TMDS clock frequency), thus outputting played-back contents in the determined output format.

Accordingly, even if disconnection with the content receiving device 40 occurs, this modification sets the output format at the reconnection with the content receiving device 40. For this reason, even if the HDMI cable 30 were changed, it could be possible to eliminate a trouble of, due to the HDMI cable 30, the disappearance of images to be displayed and the loss of sounds to be outputted.

(Third Modification)

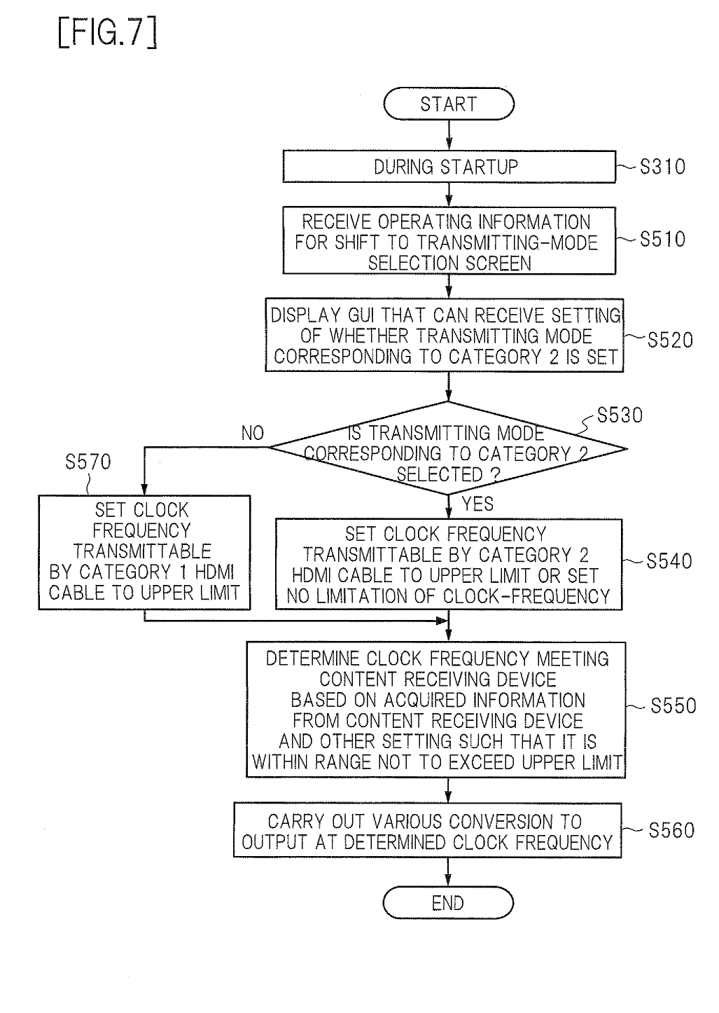

FIG. 7 is a flowchart illustrating a third modification of the output-format determining task to be executed by the content transmitting device 10.

This modification shows an output-format determining task after determination of the output format at power up in accordance with the output-format determining task of the embodiment; this output-format determining task of this modification is carried out when the transmitting mode is further changed in response to a user's intention.

During startup (step S310), when receiving the operating information for shift to the transmitting-mode selection screen for selection of whether the transmitting mode corresponding to the category 2 HDMI cable 30 is set in step S510, the content transmitting device 10 generates the transmitting-mode selection screen, and transmits it to the content receiving device 40 in step S520. Note that the transmitting-mode selection screen is outputted at the currently outputted TMDS clock frequency.

Next, the content transmitting device 10 receives the operating information from the user to thereby determine whether the transmitting mode corresponding to the category 2 HDMI cable 30 is selected in step S530.

Upon determining that the transmitting mode corresponding to the category 2 HDMI cable 30 is selected (YES in step S530), the content transmitting device 10 sets the upper limit of the TMDS clock frequency to be within a range transmittable by the category 2 HDMI cable 30, that is, sets the TMDS clock frequency to be equal to or less than 340 MHz in step S540. Note that, in this modification, the upper limit of the TMDS clock frequency is set to be within the range transmittable by the category 2 HDMI cable 30, but no upper limit of the TMDS clock frequency can be set.

Otherwise, upon determining that the transmitting mode corresponding to the category 2 HDMI cable 30 is not selected (NO in step S530), the content transmitting device 10 sets the upper limit of the TMDS clock frequency to be within a range transmittable by the category 1 HDMI cable 30, that is, sets the TMDS clock frequency to be equal to or less than 74.25 MHz in step S570.

Next, in step S550, the content transmitting device 10 determines the output format (TMDS clock frequency) based on the default setting information and user setting information stored in the storage unit 21 and on the EDID information acquired from the content receiving device 40 such that the TMDS clock frequency does not exceed the range determined in step S540 or S570.

Next, the content transmitting device 10 carries out video-conversion and audio-conversion based on the determined output format, and starts outputs at the determined TMDS clock frequency in step S560.

This results in that:

contents played back by the content transmitting device 10 when the transmitting mode corresponding to the category 2 HDMI cable 30 is selected are outputted in the transmitting mode corresponding to the category 2 HDMI cable 30; and

contents played back by the content transmitting device 10 when the transmitting mode corresponding to the category 2 HDMI cable 30 is not selected are outputted in the transmitting mode corresponding to the category 1 HDMI cable 30.

Accordingly, this modification easily changes the transmitting mode to meet the user's preference, and eliminates a trouble of, due to the HDMI cable 30, the disappearance of images to be displayed and the loss of sounds to be outputted.

Note that, when receiving, from a user, an instruction for shift to the transmitting-mode selection screen, the content transmitting device 10 according to the third modification outputs the transmitting-mode selection screen at the currently set TMDS clock frequency, but another method can be used. For example, the operations in steps S50 to S70 according to the embodiment can be carried out. Specifically, when receiving, from a user, an instruction for shift to the transmitting-mode selection screen, the content transmitting device 10 can output the transmitting-mode selection screen at the TMDS clock frequency with its upper limit being maintained within a range transmittable by the category 1 HDMI cable 30.

(Fourth Modification)

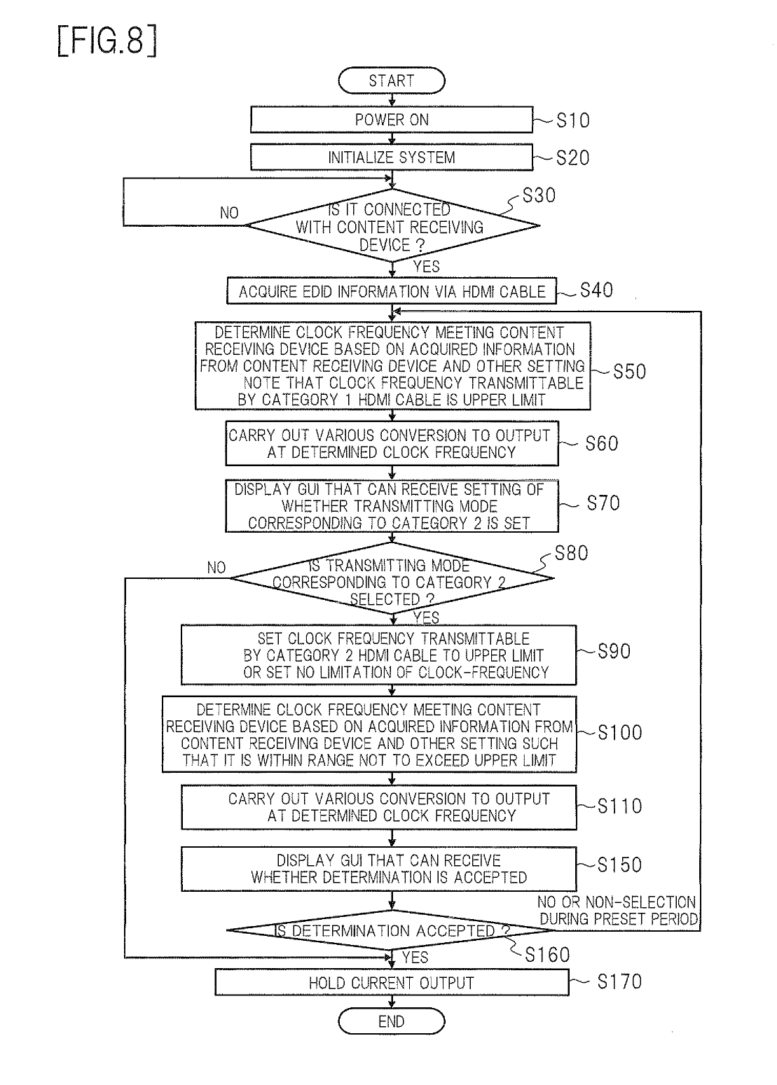

FIG. 8 is a flowchart illustrating a fourth modification of the output-format determining task to be executed by the content transmitting device 10.

This modification is configured to, when the transmitting mode corresponding to the category 2 HDMI cable 30 is selected, display a confirmation screen for checking whether the selection is accepted. This aims at, when the transmitting mode corresponding to the category 2 HDMI cable 30 is selected, making a user perform a recheck because images or sounds of played-back contents may be outputted from the content receiving device 40.

Because operations in steps S10 to S110 of FIG. 8 are the same as those in the embodiment, they are omitted in description, and therefore descriptions are started from step S150.

The content transmitting device 10 generates the confirmation screen for checking whether the determination (selection of the transmitting mode corresponding to the category 2 HDMI cable 30) is accepted, and outputs it to the content receiving device 40 in step S150. This results in that the confirmation screen is outputted at the TMDS clock frequency determined in step S100, that is, in the transmitting mode corresponding to the category 2 HDMI cable 30.

Next, the content playback device 10 receives the operating information from the user to thereby deter mine whether the determination (selection of the transmitting mode corresponding to the category 2 HDMI cable 30) is accepted in step S160.

Upon determining that the determination (selection of the transmitting mode corresponding to the category 2 HDMI cable 30) is accepted (YES in step S160), contents are outputted in the determination, that is, the output format determined in step S100 in step S170.

Otherwise, upon determining that the determination (selection of the transmitting mode corresponding to the category 2 HDMI cable 30) is not accepted or that no operating information is received even after a preset time has elapsed (NO in step S160), the content transmitting device 10 returns to step S50, and carries out determination of the output format all over again. Note that the reason for including the case where no operating instruction is received even after the preset time has elapsed is included is to address when selection cannot be carried out by a user because the confirmation screen is not displayed.

Note that, upon determining that the transmitting mode corresponding to the category 2 HDMI cable 30 is not selected (NO in step S80), the content transmitting device 10 carries out outputs by the current output format in step S170. This results in that contents played back by the content transmitting device 10 are outputted at the TMDS clock frequency determined in step S50, that is, in the transmitting mode corresponding to the category 1 HDMI cable 30.

Accordingly, this modification displays the confirmation screen in the transmitting mode corresponding to the category 2 HDMI cable 30 when a user selects the transmitting mode corresponding to the category 2 HDMI cable 30, or does not display the confirmation screen. For this reason, the user can reset the transmitting mode to the transmitting mode corresponding to the category 1 HDMI cable 30, thus further eliminating a trouble of, due to the HDMI cable 30, the disappearance of images to be displayed and the loss of sounds to be outputted.

(Fifth Modification)

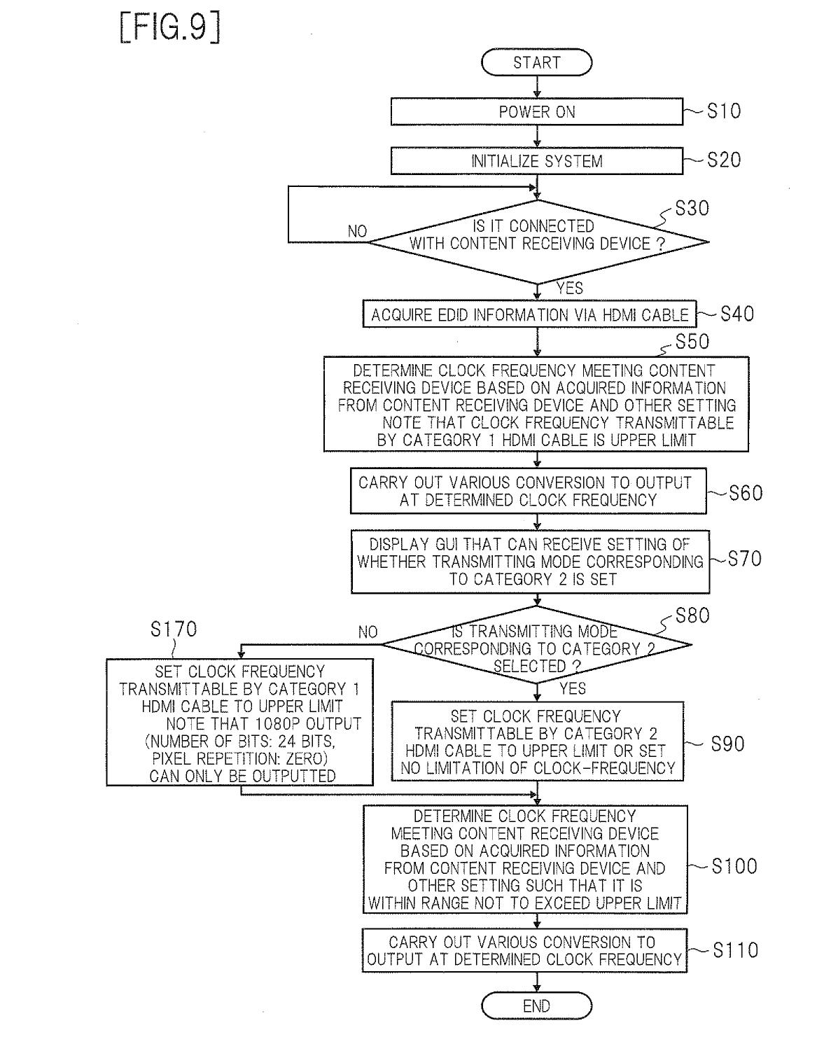

FIG. 9 is a flowchart illustrating a fifth modification of the output-format determining task to be executed by the content transmitting device 10.

This modification is configured to, even if the transmitting mode corresponding to the category 2 HDMI cable 2 is not selected, carry out the settings that allow output of an output format with the resolution, the number of bits, and the pixel-repetition being respectively set to: any one of 1080p/59.94 MHz, 1080p/60 MHz, or 1080p/50 MHz; 24 bits; and zero. This allows the TMDS clock frequency to be set to 148.352 MHz, 148.50 MHz, or 148.50 MHz.

Under normal procedures, when the transmitting mode corresponding to the category 2 HDMI cable 30 is not selected, the upper limit of the TMDS clock frequency to be set becomes 74.25 MHz, which disables the output format. However, because there is a possibility that such an output format can be transmitted through the category 1 HDMI cable 30, an exception operation is provided in the output-format determining task.

Because operations in steps S10 to S110 of FIG. 9 are the same as those in the embodiment, they are omitted in description, and operations to be carried out when the transmitting mode corresponding to the category 2 HDMI cable 30 is not selected (NO in step S80) will be described.

When the transmitting mode corresponding to the category 2 HDMI cable 30 is not selected (NO in step S80), the content transmitting device 10 determines the upper limit of the TMDS clock frequency is within a range transmittable by the category 1 HDMI cable 30, that is, the TMDS clock frequency is equal to or less than 74.25 MHz. However, the determination allows output of the following output format with the resolution, the number of bits, and the pixel-repetition being respectively set to: any one of 1080p/59.94 MHz, 1080p/60 MHz, or 1080p/50 MHz; 24 bits; and zero. In other words, the output format with the resolution, the number of bits, and the pixel-repetition being respectively set to: any one of 1080p/59.94 MHz, 1080p/60 MHz, or 1080p/50 MHz; 24 bits; and zero can be selected by a user on the output-format selection screen for voluntarily selecting the output format by a user.

Next, in step S100, the content transmitting device 10 determines the output format (TMDS clock frequency) based on the default setting information and user setting information stored in the storage unit 21 and on the EDID information acquired from the content receiving device 40 such that the TMDS clock frequency does not exceed the range determined in step S170.

Next, the content transmitting device 10 carries out video-conversion and audio-conversion based on the determined output format, and starts outputs at the determined TMDS clock frequency in step S110.

This results in that contents played back by the content transmitting device 10 are outputted at the TMDS clock frequency determined in step S100, that is, in the transmitting mode corresponding to the category 1 HDMI cable 30.

Accordingly, this modification has the same effects as the embodiment, and allows determination of a specific output format selectable by a user even if the category 1 HDMI cable 30 is selected, making it possible to improve user's convenience.

Note that, in each of the embodiment and these modifications, the output-format determining task for the two types of HDMI cables have been described, but when three or more types of HDMI cables are present, it is possible to meet the three or more types of HDMI cables. Specifically, a transmitting-mode selection screen is outputted in the transmitting mode corresponding to one category HDMI cable with the lowest transmission bandwidth; this transmitting-mode selection screen allows an alternative category HDMI cable to be selected. When information indicative of the transmitting mode corresponding to an alternative category HDMI cable is received, the transmitting mode corresponding to an alternative category HDMI cable with a higher transmission bandwidth is determined.

The embodiments of the present invention have been described, but the present invention is not limited thereto, and they can be subjected to various deformations and modifications within the scope of the present invention. The embodiments with these various deformations and modifications are also within the scope of the present invention.

1. A content transmitting device connected with a content receiving device via any one of two types of first and second cables, the first cable having a guaranteed transmission bandwidth with a first frequency, the second cable having a guaranteed transmission bandwidth higher than the first frequency, the content transmitting device comprising:
an acquiring means performing a device-information acquiring process to acquire, from the content receiving device, information associated with a specification of the content receiving device; and
a content transmitting means performing:
a first clock frequency determining process to determine an output format and a clock frequency of a signal to be outputted on ground that the acquired information associated with the specification of the content receiving device such that the clock frequency is equal to or less than the first frequency;
a first output control process to output, at the clock frequency determined by the first clock frequency determining process, a selection screen for selecting whether to set a transmitting mode corresponding to the second cable;
a second clock frequency determining process to:
determine an output format and a clock frequency of a signal to be outputted on ground that the acquired information associated with the specification of the content receiving device when receiving information representing that the transmitting mode corresponding to the second cable is set, and
determine holding of the output format and the clock frequency determined by the first clock frequency determining process when receiving information representing that the transmitting mode corresponding to the second cable is unset; and
a second output control process to output, at the clock frequency determined by the second clock frequency determining process, a content to the content receiving device.

2. The content transmitting device according to claim 1, wherein the content receiving device and the content transmitting device conform to HDMI specifications, and the first and second cables are HDMI cables.

3. The content transmitting device according to claim 1, wherein the second clock frequency determining process determines, when receiving the information representing that the transmitting mode corresponding to the second cable is set, the output format and the clock frequency such that the clock frequency of the signal to be outputted is equal to or less than a second frequency that is a transmission bandwidth of the second cable.

4. The content transmitting device according to claim 1, wherein, during power up of the content transmitting device, the acquiring means performs the device-information acquiring process, and the content transmitting means performs the first clock frequency determining process, the first output control process, the second clock frequency determining process, and the second output control process.

5. The content transmitting device according to claim 1, further comprising a storage means to store information associated with the output format and the clock frequency determined by the second clock frequency determining process,
wherein the content transmitting means performs a device-change determining process for determining, from the information associated with the specification of the content receiving device and acquired by the device-information acquiring process, whether the content receiving device is changed, the content transmitting means performing:
the first clock frequency determining process, the first output control process, the second clock frequency determining process, and the second output control process when it is determined that the content receiving device is changed by the device-change determining process; and
a third output control process to output a content to the content receiving device in the output format at the clock frequency stored in the storage means.

6. The content transmitting device according to claim 1, wherein the content transmitting means performs a device-connection detecting process to detect connection of the content transmitting device with the content receiving device, and, when reconnection of the content transmitting device with the content receiving device is detected by the device-connection detecting process after detection of disconnection of the content transmitting device with the content receiving device, the acquiring means performs the device-information acquiring process and the content transmitting means performs the first clock frequency determining process, the first output control process, the second clock frequency determining process, and the second output control process.

7. The content transmitting device according to claim 1, wherein the content transmitting means performs the first clock frequency determining process, the first output control process, the second clock frequency determining process, and the second output control process when an operating instruction occurs from a user.

8. The content transmitting device according to claim 1, wherein, when an operating instruction occurs from a user, the content transmitting means performs the first output control process, the second clock frequency determining process, and the second output control process,
the first output control process outputting, at a currently set clock frequency in place of the clock frequency determined by the first clock frequency determining process, the selection screen for selecting whether to set the transmitting mode corresponding to the second cable,
the second clock frequency determining process determining, when receiving the information representing that the transmitting mode corresponding to the second cable is unset, the output format and the clock frequency on ground that the acquired information associated with the specification of the content receiving device such that the clock frequency of the signal to be outputted is equal to or less than the first frequency.

9. The content transmitting device according to claim 1, wherein, when receiving the information representing that the transmitting mode corresponding to the second cable is set, the second output control process outputs, at the clock frequency determined by the second clock frequency determining process, a confirmation screen for confirming the determination to the content receiving device, and, when receiving information representing that the determination is accepted, outputs, at the clock frequency determined by the second clock frequency determining process, the content to the content receiving device.

10. The content transmitting device according to claim 1, wherein, when receiving the information representing that the transmitting mode corresponding to the second cable is unset, the second clock frequency determining process determines holding of the output format and the clock frequency determined by the first clock frequency determining process, and carries out setting that a specific output format over the determined clock frequency is selectable.
